(19) United States
(12) Patent Application Publication
(10) Pub. No.: US 2005/0210266 A1
(43) Pub. Date: Sep. 22, 2005

(54) Secure device connection and operation

(76) Inventors: Andrew Paul Cottrell, (US); Karen Zelenko, (US)

Correspondence Address: PHOENIX TECHNOLOGIES LTD., 915 MURPHY RANCH ROAD, MILPITAS, CA, 95035, US

(21) Appl. No.: 10/952,304

(22) Filed: Sep. 27, 2004

Related U.S. Application Data
(60) Provisional application No. 60/554,971, filed on Mar. 18, 2004.

(51) Int. Cl. H04K 1/00

(52) U.S. Cl. 713/185; 726/7

(57) ABSTRACT

A status arbiter includes a first input operative to receive at least one of a server public key and an agent public key. A second input is operative to receive a secure confirmation signal, where the secure confirmation signal may include an encrypted signal indicating of the state of an underlying device. An authenticating means for determining the state of the underlying device is coupled to the private key input, which provides for the release of digital credentials indicating that the underlying device is secure. A secure device operating method includes receiving an authentication request. Next, providing a device credential in response to the authentication request, where the device credential is provided in response to a secure confirmation signal indicating that the underlying device is authorized to perform the authentication request.

This application claims the benefit of U.S. Provisional Application No. 60/554,971, filed Mar. 18, 2004.

### FIELD OF THE INVENTION

The present invention generally relates to electronic devices and, more particularly, to providing secure device operation and secure connection to networks.

### BACKGROUND OF THE INVENTION

As electronic devices, for example, personal computers (PC's), laptop computers, personal digital assistants (PDA's), tablet PC's; wireless communication devices, for example, cellular telephones, Internet appliances; embedded device, for example, routers and set top boxes and other suitable devices and combinations thereof become more a part of our daily lives, individuals and businesses alike are becoming more cognizant of the importance of securely using such devices. Security is of particular importance when electronic devices are connected to and perform important transactions, for example, accessing and/or transferring sensitive information over networks. Another area of concern is the increasing number of viruses that attack sensitive information, for example, e-mail addresses, bank accounts and other suitable information resident on the hard drives of electronic devices.

Currently, the most employed technique used to prevent unwanted access and manipulation of information over a network, or prevent the spreading of viruses, is to prevent an unauthorized device from gaining access to the network or other resource that maintains sensitive information. Typically, for an electronic device to gain access to a network, a calling program would request access to the network. The corresponding network controller, in turn, would request some form of authentication or credential, for example, a challenge question from the requesting device that identifies the requesting device as being authorized to access the network or sensitive information. In some implementations, this authentication request would then be submitted to a cryptographic application interface (CAPI), which converts the request into a device specific format for receipt and processing by a corresponding cryptographic service provider (CSP) supporting the requesting device. The CSP would then retrieve the authentication information, for example, a private key stored in the hard drive of the electronic (e.g. requesting) device and use the private key to perform operations, for example, generate unique credentials to sign the challenge response and transmit the signed challenge response to the network controller. If the authentication information is authorized to access the network or other sensitive information, the network controller will grant access; otherwise, access will be denied.

A drawback with the aforementioned technique is that it does not prevent an electronic device having a virus present therein from gaining access to the network and causing significant damage to the network, the information contained on the network or the other devices that may be connected to the network. Additionally, the aforementioned and other conventional techniques do not prevent an electronic device from operating in a non-secure manner or non-secure mode.

### SUMMARY OF THE INVENTION

A status arbiter for use in providing secure device operation, for example, secure connection to network, includes a first input operative to receive at least one of a server public key and an agent public key. The arbiter further includes a second input operative to receive a secure confirmation signal, where the secure confirmation signal may include an encrypted signal indicating the state of an underlying device. An authenticating means for determining the state of the underlying device is coupled to the second input, which provides for the release of digital credentials indicating that the underlying device is secure. A secure device is confirmed as being virus free and/or having the latest version of anti-virus software present, for example, in the hard drive therein.

A secure device operating method includes receiving an authentication request. Next, a device credential is provided in response to the authentication request, where the device credential is provided in response to a secure confirmation signal indicating that the underlying device is authorized and in an authorized state to perform the authentication request.

An advantage provided by the present invention is that it prevents virus attacks from remote locations along a network by preventing network access to those devices that have viruses detected or present thereon or devices that do not have the latest version of applicable virus detection/eradication software present therein.

### BRIEF DESCRIPTION OF THE DRAWINGS

The present invention and the advantages and features provided thereby will be best appreciated and understood upon review of the following detailed description of the invention, taken in conjunction with the following drawings, where like numerals represent like elements, in which:

FIG. 1 is a schematic block diagram of an exemplary electronic device implementing the secure connection and operation functionality according to the present invention;

FIG. 2 is a schematic block diagram of an exemplary wireless communication system including an electronic device configured to implement the secure connection and operation functionality according to the present invention; and

FIG. 3 is a flow chart illustrating the operations performed by an electronic device when implementing the secure connection and operation functionality according to the present invention.

### DETAILED DESCRIPTION OF THE INVENTION

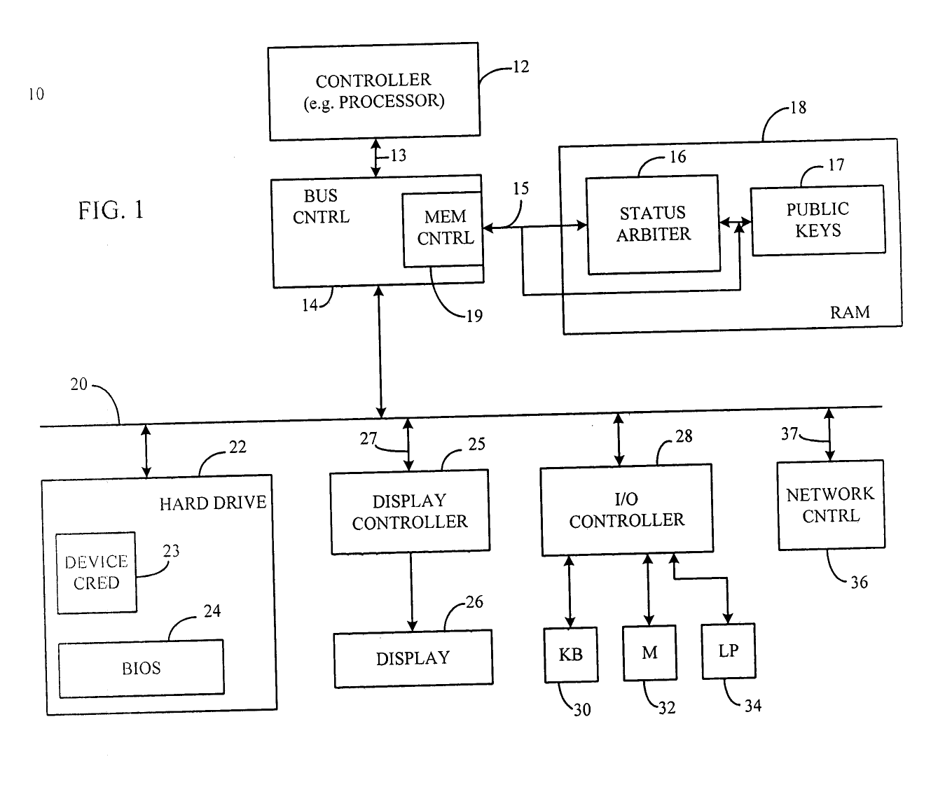

An exemplary embodiment of the present invention will now be described with reference to FIGS. 1-3. FIG. 1 is a schematic block diagram of an electronic device 10 including a status arbiter 16 configured to implement the secure interconnection and operation functionality according to the present invention. For purposes of illustration and description, and not limitation, the electronic device 10 is represented as a tablet personal computer (tablet PC). It will be appreciated by those of ordinary skill in the art that the electronic device 10 may be embodied as a personal computer, laptop computer, personal digital assistant (PDA's); wireless communication devices, for example, cellular telephones; Internet appliances; embedded device, for example, a router or set top box and other suitable devices and combinations thereof.

The tablet PC 10 includes at least one controller or processor 12 configured to control the overall operation of the tablet PC 10. The processor 12 may include an arithmetic logic unit (ALU) for performing computations, one or more registers for temporary storage of data and instructions, and a controller for controlling the operations of the tablet PC 10. In one embodiment, the processor 12 includes any one of the X86, Pentium™ and Pentium Pro™ microprocessors manufactured by Intel Corporation, or the K-6 microprocessor marketed by Advanced Micro Devices. Further examples include the 6×86MX microprocessor as marketed by Cyrix Corp., the 680×0 processor marketed by Motorola; or the Power PC™ processor marketed by International Business Machines. In addition, any of a variety of other processors, including those from Sun Microsystems, MIPS, NEC, Cyrix and others may be used for implementing the processor 12. The processor 12 is not limited to microprocessors, but may take on other forms such as microcontrollers, digital signal processors (DSP), dedicated hardware (e.g. ASIC), state machines or software executing on one or more processors distributed across a network.

The processor 12 is coupled to a bus controller 14 by way of a CPU bus 13. The bus controller 14 includes a memory controller 19 integrated therein. The memory controller 19 provides for access by the processor 12 or other devices to system memory 18, for example, random access memory (RAM) or other fast access memory device. The bus controller 14 is coupled to a system bus 20, for example, a peripheral component interconnect (PCI) bus, industry standard architecture (ISA) bus, universal serial bus (USB), a wireless connection or other suitable communication medium. Coupled to the system bus 20 is a hard drive 22, for example, a non-volatile memory such as a flash memory or read only memory (ROM), a display controller 25, operative to transfer data 27 for display on a corresponding display device 26, an input output (I/O) controller 28 and a network controller 36, for example, a wireless network controller.

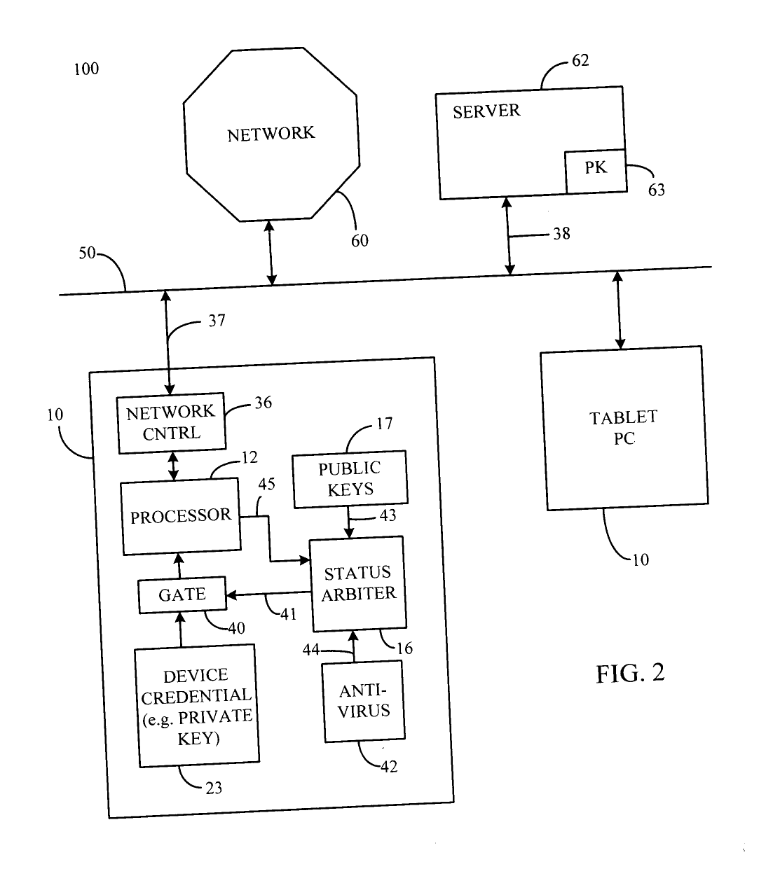

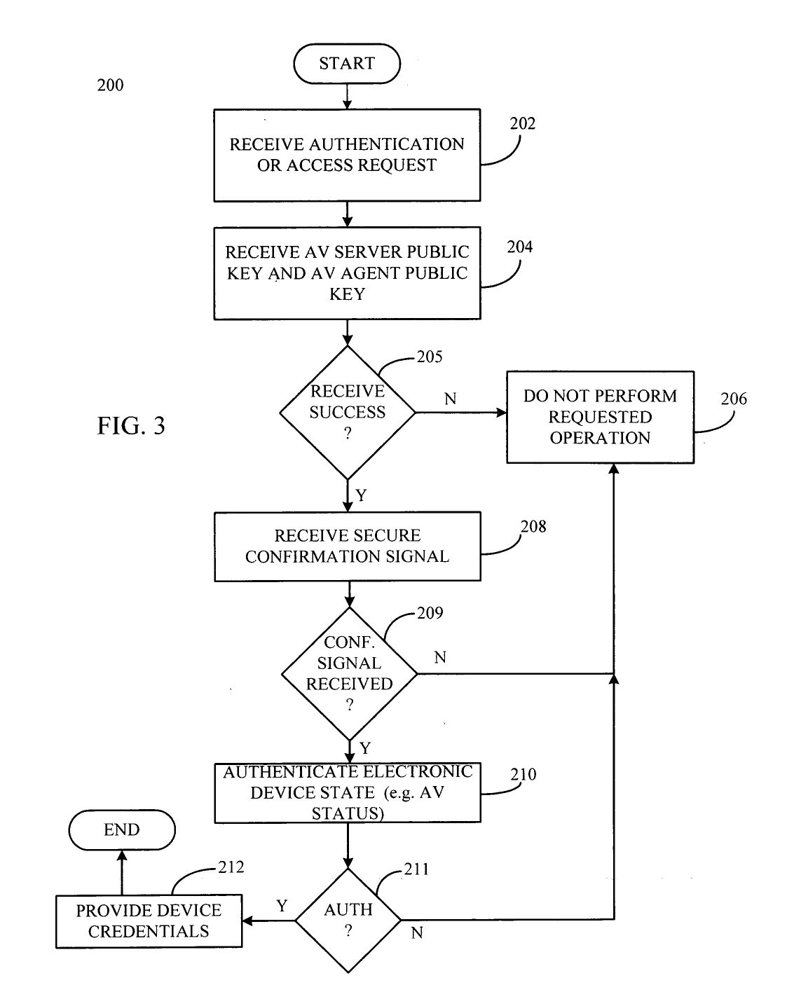

A status arbiter 16 is coupled to the processor 12 via the memory controller 19 portion of the bus controller 14. In an exemplary embodiment, the status arbiter 16 is implemented as a series of operating instructions that are transferred to the system memory 18 after device initialization and executed by the at least one processor 12, which subsequently causes the at least one processor 12 to perform secure operations or act in a secure manner as described in greater detail below with respect to FIGS. 2-3. As used herein, a secure device is a device certified as being virus free and/or having the latest version of applicable anti-virus software 42 (FIG. 2), for example, McAfee ePolicy Orchestrator distributed by Network Associates, Inc, Santa Clara, Calif., present in a hard drive 22 or other suitable location. Although illustrated as being operating instructions maintained within the system memory 18, the status arbiter 16 may be implemented as a stand alone component, for example, an ASIC, discrete logic, state machine, or other suitable device capable of executing a series of instructions or a series of instructions maintained on a computer readable medium that is inserted into an appropriate reader, which then transmits the series of instructions to the processor 12 or other suitable controller for execution.

When implemented in software, the elements of the present invention are essentially the code segments to perform the necessary tasks. The program or code segments can be stored, for example, in a processor readable medium or transmitted by a computer data signal embodied in a carrier wave over a transmission medium or communication link. The processor readable medium may include, for example, an electronic circuit, a semiconductor memory device, a ROM, RAM, a flash memory, an erasable ROM (EROM), a floppy diskette, a CD-ROM, an optical disk, a hard disk, a fiber optic medium, a radio frequency (RF) link or any suitable medium or combination thereof. The computer data signal may include any signal that can propagate over a transmission medium, for example, electronic network channels, optical fibers, air, electromagnetic, RF links or any other suitable medium or combination thereof. The code segments may be downloaded via computer networks, for example, the Internet, LAN, WAN or any suitable network or combination thereof.

Public keys 17, for example, keys related to an anti-virus server or anti-virus agent or other suitable component that maintains the latest version of applicable anti-virus software, for example, McAfee ePolicy Orchestrator is maintained in the system memory 18. However, one of ordinary skill in the art will appreciate that the public keys 17 and corresponding anti-virus software 42 (FIG. 2) may be maintained in any location that is accessible by the tablet PC 10.

The hard drive 22 has device credentials 23, for example, private keys stored therein that are used to authenticate the tablet PC 10 to other devices or a larger network and basic input and output system (BIOS) software code 24 that is used, for example, to initialize and configure the subsystems, for example, the display controller 25, I/O controller 28 and network controller 36 of the tablet PC 10 in a specified manner. It will be appreciated by those of ordinary skill in the art that the device credentials 23 may be stored in any location that is accessible by the tablet PC 10. The use of the device credentials 23 in providing the secure connection and operation functionality of the present invention will be discussed in greater detail below with respect to FIGS. 2-3.

The display controller 25 may be implemented by any suitable device, for example, graphics processor capable of formatting digital data 27 for proper display and viewing on a corresponding display device 26, for example, a flat panel display, CRT display, printer, plotter or other suitable presentation device and combinations thereof.

The I/O controller 28 may be implemented by any suitable device capable of transferring information, for example, signals containing data and/or instructions between the processor 12 and a variety of input or output devices including, but not limited to, a keyboard 30, mouse 32 and pen input 34. The pen input 34 may be implemented as a touch screen, soft keys, optical input device or other suitable input devices or combinations thereof.

The network controller 36 may be implemented, for example, by a wireless network access controller or other suitable device or applicable software capable of connecting the underlying tablet PC 10 to a larger network, for example, the Internet.

FIG. 2 is a schematic block diagram of an exemplary wireless communication system 100, including at least one tablet PC 10 configured to implement the secure connection and operation functionality according to the present invention. As shown, the tablet PC 10 is one of a plurality of electronic devices that may connect to a remote network 60 or remote server 62 via a wireless network or conduit 50, for example, a wide area network (WAN) that connects to a remote local area network (LAN). In an exemplary embodiment, the tablet PC 10 will only gain access to the network 60 by demonstrating that it is in a particular device state, for example, virus free and/or has the latest version of applicable anti-virus software 42 stored thereon. In an alternate embodiment, the tablet PC 10 will perform a prescribed secure operation, for example, a bank transaction or manipulate sensitive information for example, access bank account records, when the underlying tablet PC 10 demonstrates or can establish that is has obtained or is operating in a particular device state, for example, that it is virus free and/or has the latest version of applicable anti-virus software stored thereon.

In application, when the tablet PC 10 wishes to gain access to a network 60, it will request access to the network 60 via the network controller 36. This request 37 is then transmitted to the remote server 62 which, in turn, sends an authentication or access request challenge 38 to the network controller 36. The format of the authentication or access request challenge 38 is of a generic nature such that it will be recognized by a variety of different transmission protocols or devices. The authentication or access request challenge 38 is then transferred by the network controller 36 to a suitable cryptographic API (CAPI) located within the processor 12, for example, generate the digital signal (e.g. signature) CryptSignHash distributed by Microsoft Corp., Redmond, Wash. (not shown) which converts the generic request into a device specific format. The device specific format request 45 is then transmitted to a cryptographic service provider (CSP), for example, the TrustConnector™ CSP manufactured by Phoenix Technologies Ltd., Milpitas, Calif., the assignee of the present invention. This specific format request 45 is then transmitted to the status arbiter 16 which, in turn, provides for a device credential 23, for example, a private key or other suitable signal indicating that the tablet PC 10 is authorized to perform the request, for example, connect to the network 60 or perform a specified operation.

The status arbiter 16 receives as a first input server public key and agent public key information 43 corresponding to the anti-virus software 42 that is either present in (e.g. stored in system memory 18) or running on the tablet PC 10. The status arbiter 16 receives as a second input, a secure confirmation signal 44, for example, a signal indicating the status or state of the tablet PC 10. In an exemplary embodiment, the secure confirmation signal 44 is an encrypted signal indicating that the tablet PC 10 is virus free and/or that the device has the latest version of applicable anti-virus software 42 stored thereon, or that the tablet PC 10 is operating in or has obtained a suitable device state or condition, for example, critical operating system patches are applied and software and/or hardware configuration is approved. Alternatively, the secure confirmation signal 44 may be an unencrypted signal.

In an exemplary embodiment, the secure confirmation signal 44 is encrypted by a server private key and an agent (e.g. anti-virus program) public key (PK) 63 that are maintained, for example, on a remote server 62 containing the applicable anti-virus program. The encryption may be performed, for example, by RSA encryption, or RSA digital signature methods or other suitable encryption methods known to those of ordinary skill in the art. With this configuration, a single anti-virus program can be used to service a plurality of electronic devices. Alternatively, when an authentication request 45 is received, the status arbiter 16 can retrieve the secure confirmation signal 44 information from an applicable database entry, registry entry or file on a corresponding hard drive or other suitable combination thereof.

Upon receiving the server public key and agent public key 43, the secure confirmation signal 44 and the authentication request 45, the status arbiter 16 authenticates the device state, for example, the anti-virus status of the tablet PC 10 by employing standard cryptographic techniques, for example, RSA Public Key Operation, to decrypt the secure confirmation signal 44 using the pubic keys 43. If the decrypted status, for example, the result of one of the aforementioned cryptographic techniques indicates that the underlying tablet PC 10 is virus free and/or has the latest version of the applicable anti-virus software 42 stored thereon, the status arbiter 16 provides for the release of the device credentials 23, for example, by generating a control signal 41 that causes a corresponding gate 40 or other suitable switch to open; thereby, providing the device credentials 23 to be transmitted to the processor 12 which, in turn, allows the tablet PC 10 to access the network 60 (via network controller 36) or perform a specified secure operation.

Alternatively, if the decrypted status indicates that the underlying tablet PC 10 is virus free and/or has the latest version of the applicable anti-virus software 42 stored thereon, the tablet PC 10 will be allowed to operate in a secure manner. By employing the functionality of the present invention, virus attacks from remote locations along a network are prevented by preventing network access to electronic devices that have viruses detected or present thereon or devices that do not have the latest version of applicable anti-virus software present therein.

FIG. 3 is a flow chart illustrating the operations performed by the tablet PC to implement the secure connection and operation functionality of the present invention. More specifically, FIG. 3 illustrates the operations performed by the status arbiter when performing the secure connection and operation method 200 according to the present invention. In step 202, the status arbiter receives an authentication or access request. This occurs, for example, when the network controller of the tablet PC receives an authentication request or the processor receives a request to perform a secure operation.

In step 204, the status arbiter receives the server public key and agent public key from system memory.

In step 205, a determination is made as to whether the server public key and agent public key were received. If the public keys were not received, the process moves to step 206 which provides that the requested operation is not performed. This is accomplished, for example, by the processor initiating a halt or other suitable stop request. Otherwise, the process proceeds to step 208.

In step 208, the status arbiter receives the secure confirmation signal. This may be accomplished, for example, by the remote server sending an encrypted signal containing an indication that the tablet PC has no detected viruses present thereon and/or that the tablet PC has the latest version of the applicable anti-virus software stored thereon. Alternatively, the status arbiter can retrieve the electronic device state information from a database entry, a registry entry or a file on the corresponding device hard disk.

In step 209, a determination is made as to whether the secure confirmation signal was successfully received. If the secure confirmation signal was not successfully received, the process moves to step 206 which provides that the requested operation is not performed. Otherwise, the process proceeds to step 210.

In step 210, the status arbiter authenticates the secure confirmation signal, for example, by using the server public key and agent public key to decrypt the encrypted state signal using conventional decryption techniques, for example, RSA Public Key Operation known to those of ordinary skill in the art.

In step 211, a determination is made as to whether the authentication (e.g. decryption) was successful. If the authentication was not successful, the process moves to step 206 which provides that the requested operation is not performed. Otherwise, the process proceeds to step 212.

In step 212, the device credentials are provided. This is accomplished, for example, by the status arbiter generating a control signal that causes a gate or other suitable switch to open; thereby, providing the device credentials to be transmitted to the network controller which, in turn, allows the tablet PC to perform the requested operation, for example, access a given network or performing a given secure operation. The process then ends.

By employing the technique of the present invention, virus attacks from remote locations along a network are prevented by not allowing network access to electronic devices that have viruses detected or present thereon or electronic devices that do not have the latest version of applicable anti-virus software present therein. Additionally, secure device operation is accomplished by tying the ability to perform a particular operation to the device state, for example, the anti-virus status of the electronic device. If the electronic device has a virus or other unwanted condition present thereon, or the electronic device does not have the latest version of the applicable anti-virus software stored thereon, device operation will be prevented.

The foregoing detailed description of the invention has been provided for the purposes of illustration and description. Although an exemplary embodiment of the present invention has been described in detail herein with reference to the accompanying drawings, it is to be understood that the invention is not limited to the precise embodiment(s) disclosed, and that various changes and modifications to the invention are possible in light of the above teachings. Accordingly, the scope of the present invention is to be defined by the claims appended hereto.

1. A secure device operating method, comprising:
receiving an authentication request;
providing a device credential in response to the authentication request, the device credential provided in response to a secure confirmation signal indicating that the underlying device is authorized to perform the authentication request.

2. The secure device operating method of claim 1, wherein the device credential is provided by an electronic device and the secure confirmation signal indicates that the electronic device can use the device credential to securely connect to a network.

3. The secure device operating method of claim 1, wherein the authentication request further includes a request to perform a given operation.

4. The secure device operating method of claim 3, wherein the device credential is provided by an electronic device and the secure confirmation signal indicates that the electronic device can perform the requested operation.

5. The secure device operating method of claim 1, wherein the secure confirmation signal further indicates that the underlying device has the latest version of applicable anti-virus software stored thereon.

6. The secure device operating method of claim 1, wherein the secure confirmation signal further indicates that no viruses have been detected on the underlying device.

7. A method for securely connecting to a network, comprising:
receiving an authentication request;
receiving a secure confirmation signal; and
providing a device credential upon authenticating the secure confirmation signal, the device credential indicating that an underlying device may connect to the network.

8. The method of claim 7, wherein the secure confirmation signal further includes a digitally signed signal representing that the underlying device may connect to the network.

9. The method of claim 8, wherein the digitally signed signal further represents that no viruses have been detected on the underlying device.

10. The method of claim 8, wherein the digitally signed signal further represents that the underlying device has the latest version of applicable anti-virus software stored thereon.

11. The method of claim 8, wherein authenticating the secure confirmation signal further includes verifying the digitally signed signal with at least one of a server public key and an agent public key.

12. The method of claim 8, wherein authenticating the secure confirmation signal further includes loading the digitally signed signal, the digitally signed signal encrypted by at least one of a server private key and an agent private key, loading at least one of a server public key and an agent public key, and decrypting the digitally signed signal with at least one of the server public key and the agent public key.

13. A status arbiter for use in an electronic device, comprising:
a first input operative to receive at least one of a server public key and an agent public key;
a second input operative to receive a secure confirmation signal, the secure confirmation including an encrypted signal indicating the state of an underlying device; and
authenticating means for determining the state of the underlying device, wherein the status arbiter provides for the release of digital credentials indicating that the underlying device is secure.

14. The status arbiter of claim 13, wherein the digital credentials further indicate that the underlying device may connect to a network.

15. The status arbiter of claim 13, wherein the digital credentials further indicate that the underlying device perform a secure operation.

16. The status arbiter of claim 13, further including decryption means for decrypting the encrypted secure confirmation signal with one of the at least server public key and agent public key.

17. A device operating method, comprising:
receiving an authentication request;
receiving a secure confirmation signal; and
providing a device credential upon authenticating the secure confirmation signal, the device credential indicating that an underlying device is operating in a particular state.

18. The device operating method of claim 17, wherein the secure confirmation signal further includes a digitally signed signal representing that the underlying device has the latest version of applicable anti-virus software maintained therein, and wherein authenticating the secure confirmation signal further includes verifying the digitally signal with at least one of a server public key and an agent public key.

19. The device operating method of claim 18, wherein authenticating the secure confirmation signal further includes loading the digitally signed signal, the digitally signed signal encrypted by at least one of a server private key and an agent private key, loading at least one of a server public key and an agent public key, and decrypting the digitally signed signal with at least one of the server public key and the agent public key.

20. An electronic device, comprising:
a processor; and
a memory, coupled to the processor, for maintaining instructions that when executed by the processor, cause the processor to:
receive an authentication request,
receive a secure confirmation signal, and
provide a device credential upon authenticating the secure confirmation signal, the device credential indicating that the electronic device is operating in a particular state.

21. The electronic device of claim 20, wherein the secure confirmation signal includes a digitally signed signal, and wherein the instructions further cause the processor to authenticate the secure confirmation signal by verifying the digitally signed signal with at least one of a server public key and an agent public key.
